(19) United States
(12) Patent Application Publication
(10) Pub. No.: US 2012/0055232 A1
(43) Pub. Date: Mar. 8, 2012

(54) Photoacoustic Gas Detector with Integrated Signal Processing

(75) Inventor: Walter R. Thorson, Calgary (CA)

(73) Assignee: Honeywell International Inc., Morristown, NJ (US)

(21) Appl. No.: 12/876,501

(22) Filed: Sep. 7, 2010

(51) Int. Cl. G01N 21/17

(52) U.S. Cl. 73/24.02

(57) ABSTRACT

A flexible gas sensor includes a housing with a predetermined form factor, a photoacoustic gas sensing chamber, and at least one of acoustic, temperature, relative humidity or pressure sensors in combination with processing circuitry which can emulate the characteristic gas response output of a catalytic bead pellistor-type gas sensor in response to a selected gas. The processing circuitry can include a programmable processor and a storage unit. The storage unit can be loaded with data and executable instructions to specify, at least in part, how the signals from the photoacoustic sensor are to be processed by the processing circuitry.

### FIELD

The invention pertains to photoacoustic gas sensors usable with flammable and/or toxic gases. More particularly, the invention pertains to such photoacoustic gas sensors which can be substituted for sensors which incorporate known catalytic bead pellistor-based sensor elements.

### BACKGROUND

Various types of photoacoustic sensors are known to detect gases. These include, Fritz et al., US patent application No. 2009/0320561, published Dec. 31, 2009 and entitled “Photoacoustic Cell”; Fritz et al., US patent application No. 2010/0027012, published Feb. 4, 2010 and entitled, “Photoacoustic Spectroscopy System”; Fritz et al., US patent application No. 2010/0045998, published Feb. 25, 2010 and entitled “Photoacoustic Sensor”; and Tobias, US patent application No. 2010/0147051, published Jun. 17, 2010 and entitled, “Apparatus and Method for Using the Speed of Sound in Photoacoustic Gas Sensor Measurements. The above noted published applications have been assigned to the assignee hereof, and are incorporated herein by reference.

In another type of gas sensor well known in the art, detection of the toxic or flammable gas of interest is accomplished using one or more catalytic bead pellistor sensing elements. Such gas sensors are in common use in sensing flammable gases, and are also occasionally used for the detection of high concentrations of certain toxic gases such as ammonia. Pellistor sensors have several inherent limitations including relatively high power consumption to maintain a proper temperature of the pellistor bead element, and they can be permanently damaged by exposure to silicone or siloxane vapors or to high concentrations of sulfurous gases. Catalytic bead pellistor sensors usually incorporate a Wheatstone bridge measurement circuit, with reference and sensing pellistor bead elements disposed in different legs thereof, such that a differential output signal is produced when the sensor is exposed to the gas or gases of interest.

It would be desirable to be able to offer commercial and industrial users alternates to the known catalytic bead pellistor-type sensors so that users have additional choices and can migrate to photoacoustic-type gas sensors. The photoacoustic technology offers superior performance in terms of sensor operating life expectancy, reduced power consumption, improved stability, and immunity to the sensor bead poisoning problems often associated with pellistor sensors. To this end, it is desirable to obtain a photoacoustic gas sensor conforming to industry standard form factors and electrical interfaces that emulate those of catalytic bead pellistor sensors, so that the photoacoustic sensor technology can be deployed as a drop-in replacement in existing gas detectors, as well as in new instrument designs, without requiring significant modifications to the interface electronics or the layout and packaging of the host gas detection instrument.

### BRIEF DESCRIPTION OF THE DRAWINGS

FIG. 1 is a block diagram of a photoacoustic gas sensor which embodies the invention.

FIG. 2 depicts a preferred embodiment of the invention, conforming to an industry standard form factor of catalytic bead pellistor gas sensors; and

FIG. 3 is an alternate embodiment of the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Embodiments of the invention can be configured so as to electrically and mechanically emulate the performance and form factor of pellistor-based gas sensors. Such embodiments could include on-board electronics which could generate fully compensated and linearized output signals, normalized signals where the sensor output is adjusted to a preferred output range, and from a form factor and external interface standpoint be plug-compatible replacements for existing pellistor-based gas sensors.

In one aspect of the invention, the sensor(s) structure and the related electronics and signal processing circuitry could be implemented in an integrated form in a single housing with a selected form factor. In another aspect of the invention, the electronic and signal processing circuitry within the sensor can incorporate on-board measurement of ambient conditions such as temperature, pressure, humidity, ambient acoustic noise, vibration, or dynamic pressure fluctuations, and provide a sensor output that is compensated for the effects of these ambient conditions on the photoacoustic gas concentration measurement. Linearization of the sensor output signal and/or automatic gas concentration range selection can also be provided relative to one or more gases of interest. In yet another aspect, the on-board electronics and signal processing circuitry can include a programmable processor or microcontroller, and associated memory storage unit(s). Executable instructions can be stored in a portion of the memory storage unit(s). Information pertaining to one or more gases to be sensed can be loaded in the factory at manufacture or subsequently in the field at installation, with the result that a common electronic platform and sensor structure can be used in a variety of installations, and with a variety of sensed gases, with only minimal software or component changes needed in the respective sensor(s).

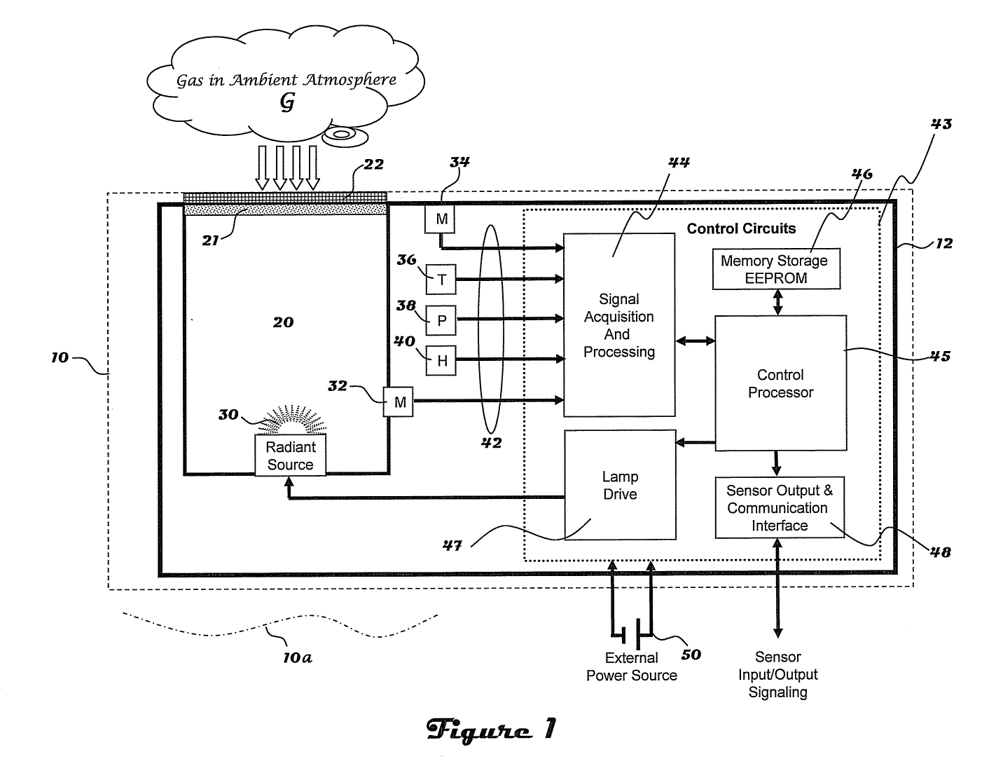

FIG. 1 illustrates a photoacoustic gas sensor 10 which embodies the invention. Sensor 10 is carried in a sensor housing 12 having a predetermined form factor depending on the particular type of gas and environment in which use is expected. Sensor housing 12 can have a cylindrical or rectangular prism form factor, without limitation. Sensor 10 can be incorporated into a gas detection apparatus 10a, as would be understood by those of skill in the art.

Housing 12 carries a gas sensing chamber 20 which is separated from the ambient atmosphere by a gas permeable membrane or structure 21 through which gas G from the ambient atmosphere may readily diffuse. In cases of an explosive or flammable gas sensor, gas permeable membrane 21 can be covered or substituted with a suitable flame arrestor, for example, a gas permeable metal mesh or sinter, 22.

Components of the gas sensor include a source of radiant energy 30, which could be implemented with a laser diode, light emitting diode (LED), incandescent lamp and suitable bandpass filter, or other source of infrared or other selected wavelengths of radiation, as would be understood by those of skill in the art. Acoustic sensor(s), such as microphone 32, detect the characteristic acoustic pressure wave produced by periodic amplitude or wavelength modulation of the radiant source, 30, and the subsequent absorption of selected wavelength(s) of radiation by the target gas to be detected. A second ambient acoustic sensor such as microphone 34 is located outside of the gas sensing chamber 20 and is used to obtain ambient noise or vibration signals to be subtracted from the photoacoustic gas response signal obtained from acoustic sensor 32 inside the sensing chamber.

Additional measurement-compensating sensors such as thermal sensor 36, pressure sensor 38 and humidity sensor 40 can be suitably located inside sensor body 12 to provide further independent compensatory signals. Signals 42 from the above noted sensors can be coupled to control circuits 43. The control circuits can include signal acquisition and processing circuitry, 44, a programmable control processor 45 associated executable instructions stored in a memory storage unit, 46, for example, EEPROM-type storage, lamp drive circuitry, 47 and sensor output and communication interface circuitry 48, capable of generating an analog output signal that emulates that of a catalytic bead pellistor gas sensor. The output circuit uses digital data from the programmable processor 45 to drive a Digital to Analog Converter chip (or DAC) to generate an output voltage that varies in proportion to the concentration of the gas measured by the sensor, thereby emulating the bridge voltage output of a catalytic bead pellistor gas sensor.

Alternately, the sensor input/output circuit 48 can be configured to provide a linear analog voltage output or a digital signal output in cases where a pellistor emulating output is not required or desirable. The ability to configure the sensor input/output interface according to the signaling interface requirements of a host gas detection instrument provides additional flexibility for using the photoacoustic gas sensor as a suitable replacement sensor for other types of gas sensors. Furthermore, gas sensor 10 can be equipped with bi-directional digital communications providing the ability to control and configure the gas sensor, and to obtain from the sensor other useful diagnostic and operational information such as temperature, humidity and pressure readings, operational status, configuration parameters, and fault conditions in addition to a gas concentration reading.

Sensor 10 is energized by a battery or other external source of power, 50.

Those of skill will understand that the processing and control circuits 43 can process the signals 42 to produce one or more output signals indicative of a gas concentration in the sensing chamber 20 of one or more selected gases. Signal processing can include the use of lock-in amplification and other signal processing techniques to acquire the photoacoustic gas response signal and to remove noise and vibration effects, as well as applying algorithms to data from sensors 34, 36, 38 and 40 to compensate the gas concentration reading for changing environmental effects of noise, vibration, temperature, pressure or humidity.

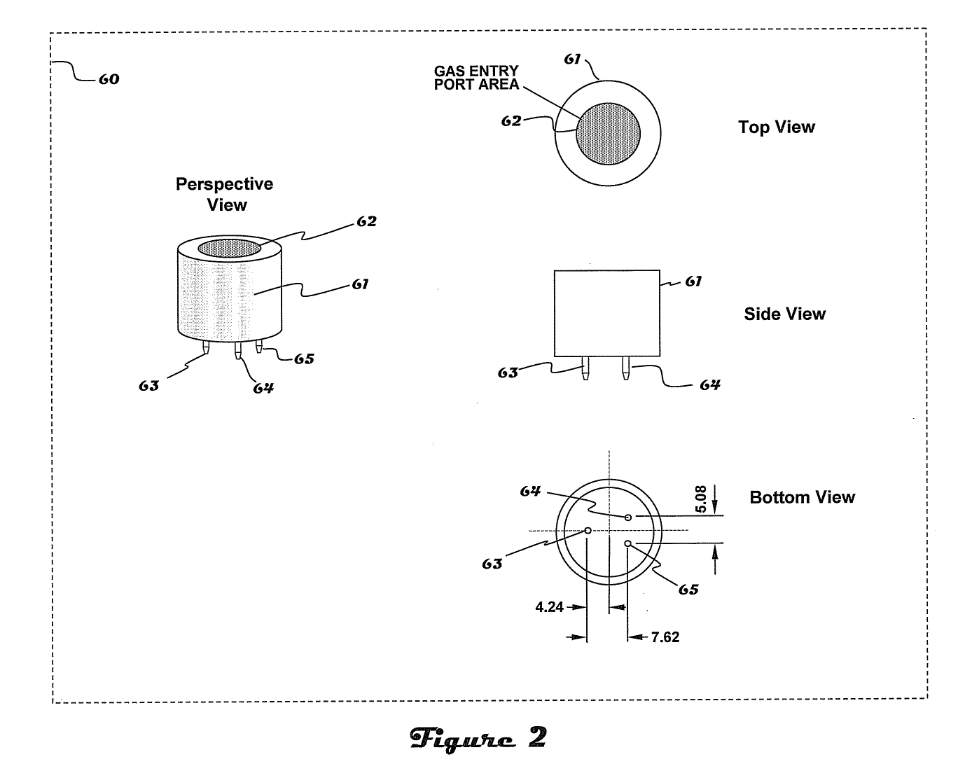

FIG. 2 depicts top, side and bottom views of a preferred embodiment of the invention where the photoacoustic gas sensor is packaged in an industry standard form factor for catalytic bead pellistor gas sensors, 60. The preferred sensor body 62 is a cylinder of nominal diameter 20.4 mm±0.5 mm and nominal height of 16.6 mm±0.5 mm. A gas entry port 62 comprising a gas permeable membrane in isolation or in combination with a wire mesh flame arrestor or a metal sinter flame arrestor is disposed in the top face of the sensor, through which gas may enter into the gas sensing cell. Electrical connection pins 63, 64 and 65 protrude from the bottom face of the gas sensor body in the preferred locations shown in the drawing. Connection pin 63 is used to provide the pellistor bridge emulating sensor output signal representing the sensed gas concentration reading. Connection pins 64 and 65 are used to supply a suitable DC voltage to the gas sensor, and may be provided in configurations were either pin 64 is at a positive voltage potential relative to pin 65, or in configurations where pin 65 is at a positive voltage potential relative to pin 64. This is because catalytic bead pellistors can be provided in either polarity configuration depending on application.

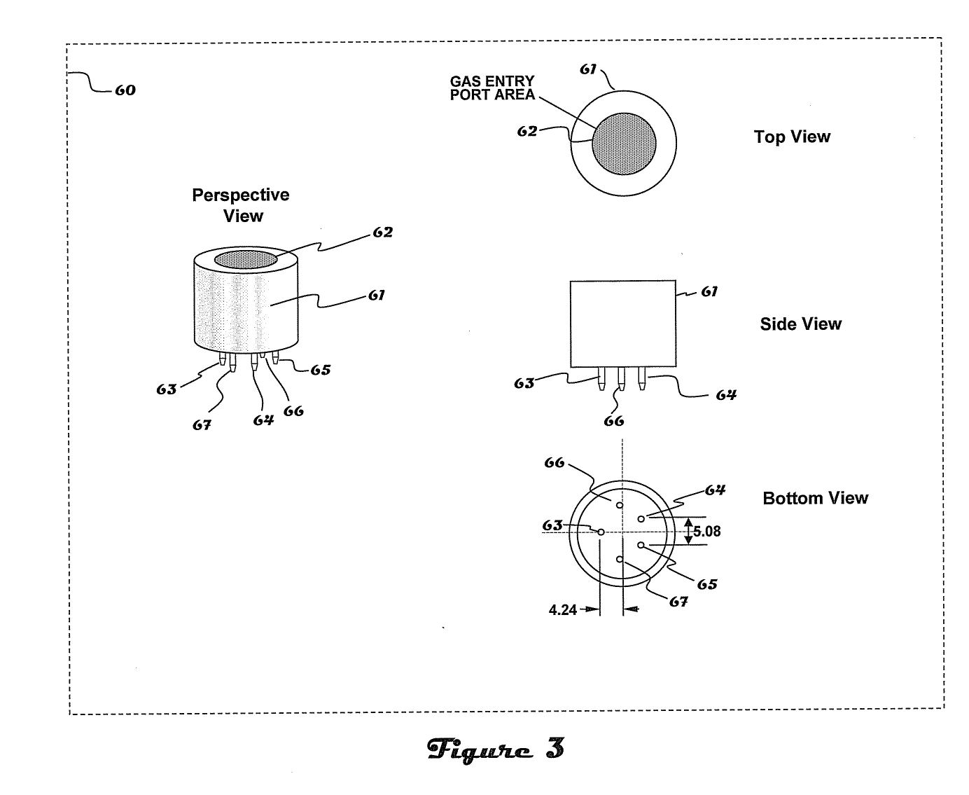

FIG. 3 depicts top, side and bottom views of a second preferred embodiment of the invention which additionally includes digital transmit connection pin 66 and digital receive connection pin 67, as required to support digital communications between the gas sensor 60 and a host gas detection apparatus. The placement locations of pins 66 and 67 on the bottom face of the sensor are exemplary as would be understood by those with skill in the art. The preferred locations of the pellistor emulating electrical connection pins 63, 64 and 65 are shown in the drawing. Exemplary dimensions are in millimeters.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A photoacoustic gas sensor comprising:
a housing having a predetermined physical form factor;
a photoacoustic gas sensing chamber carried in the housing; and
processing circuitry carried in the housing and communicatively coupled to the sensing chamber, to process signals from the sensing chamber to produce an output signal responsive to at least one gas sensed by the photoacoustic gas sensor, said output signal emulating the characteristic gas response output signal of a catalytic bead pellistor gas sensor.

2. A photoacoustic gas sensor as in claim 1 where the housing defines a gas diffusion port and a flame arrestor which covers the port, at least in part.

3. A photoacoustic gas sensor as in claim 1 where the housing defines a gas diffusion port which is covered by a gas permeable member.

4. A photoacoustic gas sensor as in claim 3 where the gas permeable member comprises a flame arrestor.

5. A photoacoustic gas sensor as in claim 1 which includes at least one of an ambient acoustic sensor, a thermal sensor, a pressure sensor or a humidity sensor carried by the gas sensor housing.

6. A photoacoustic gas sensor as in claim 5 where the processing circuitry includes circuitry for producing output signals compensated by outputs from the at least one of an ambient acoustic sensor, a thermal sensor, a pressure sensor, or an humidity sensor carried by the gas sensor housing.

7. A photoacoustic gas sensor as in claim 5 which includes circuitry to generate a normalized output signal based on at least one of; the type of gas sensed, the gas concentration range, or a preferred sensor output range.

8. A photoacoustic gas sensor as in claim 5 which includes circuitry to generate a linearized output signal based on the type of gas and gas concentration.

9. A photoacoustic gas sensor as in claim 6 where the processing circuitry includes programmable circuitry and at least one pre-stored data table for carrying out the processing.

10. A photoacoustic gas sensor as in claim 9 which includes a storage unit load able with a data table.

11. An integrated photoacoustic gas sensor comprising:
a gas sensing chamber;
a source of radiant energy which directs the energy into the sensing chamber;
a plurality of sensors carried in the gas sensor body, including at least one acoustic signal sensor, a thermal sensor, a pressure sensor and a humidity sensor;
control circuits coupled to the sensors to process photoacoustic or ambient environment-related signals from at least some of the sensors to produce at least one of a compensated, normalized or linearized gas concentration-indicating output signal.

12. An integrated photoacoustic gas sensor as in claim 11 where the control circuits include pre-stored data and executable instructions pertaining to at least one of the compensation, normalization, or linearization of a sensor output signal corresponding to a sensed gas concentration.

13. An integrated photoacoustic gas sensor as in claim 11 which includes processing circuitry and executable instructions to produce an output signal responsive to a target gas to be detected, said output signal emulating the gas response output signal characteristics of a catalytic bead pellistor gas sensor.

14. An integrated photoacoustic gas sensor as in claim 13 carried in a gas sensor body comprising a cylindrical housing of outside diameter 20.4 mm±0.3 mm, and height 16.6 mm±0.3 mm.

15) A photoacoustic gas sensor as in claim 12, where the control circuits include digital transmit and receive interface circuitry disposed to provide external bi-directional digital communications for the gas sensor.
